(19) United States
(12) Patent Application Publication
(10) Pub. No.: US 2021/0048377 A1
(43) Pub. Date: Feb. 18, 2021

(54) System and Method for Automation of Sample Pretreatment Operations for Peptide Mapping

(71) Applicant: Ilkka Lahdesmaki, Seattle, WA (US)

(72) Inventors: Ilkka Lahdesmaki, Seattle, WA (US); Daniel Hasle, Seattle, WA (US)

(73) Assignee: FIAlab Instruments, Inc., Seattle, WA (US)

(21) Appl. No.: 16/539,736

(22) Filed: Aug. 13, 2019

(51) Int. Cl. G01N 1/38; G01N 1/14

(52) U.S. Cl. CPC G01N 1/38; G01N 1/14

(57) ABSTRACT

A system and method are described for the purpose of automated sample pretreatment operations for peptide mapping analysis. The system processes fluid samples by some or all of the following operations: purification, denaturation, reduction, alkylation, desalting and enzymatic digestion. In some of the presented configurations, UV absorbance monitoring is used to estimate the efficiency of the purification or desalting steps. The processed sample is delivered to a High Performance Liquid Chromatography (HPLC) instrument for separation and analysis.

The system and method are unique in administering the automated chemical treatment of the sample in such a way that the sample and reagent(s) are combined as homogeneous mixtures. Another previously unknown feature is the option of in-line UV absorbance measurements to monitor the purification and desalting steps.

### CLASSIFICATIONS

### G01N35/1097

Devices for transferring samples or any liquids to, in, or from, the analysis apparatus, e.g. suction devices, injection devices for supplying the samples to flow-through analyzers characterized by the valves

### G01N35/085

Flow Injection Analysis

### G01N2001/382

Diluting, dispersing or mixing samples using pistons of different sections

### G01N2035/00544

Mixing by a special element, e.g. stirrer using fluid flow

### Y10T436/11

Automated chemical analysis

### Y10T436/25

Chemistry: analytical and immunological testing including sample preparation

### Y10T436/2575

Volumetric liquid transfer

### G01N33/68

Chemical analysis of biological material, involving proteins, peptides or amino acids

### BACKGROUND OF THE INVENTION

Peptide mapping is an evolving assay implemented to determine a biomolecule's quality. Peptide mapping methods have gained recent interest for their strengths in monitoring the production of monoclonal antibodies (mABs) and other biopharmaceuticals (T. Mouchahoir, et al., Analytical Bioanalytical Chem, 2018, 410:2111-2126). These methods have been found to aid scientists in understanding site-specific information on post-translational and chemical modifications in the stages of protein production. Therefore, once designed, a peptide mapping protocol can be utilized in various situations for sample analysis during the biopharmaceutical production process.

A typical peptide mapping protocol is a multi-step process, involving sample pretreatment by an assortment of denaturation, reduction, alkylation and digestion operations. Following the pretreatment process, the sample is sent to a high-performance liquid chromatograph (HPLC) for ultraviolet (UV) and/or mass spectrometry (MS) detection. The elaborate pretreatment requirement makes the protocol meticulous and labor-intensive, which poses an issue for use in product quality monitoring, where determinations need to be performed daily to ensure product is forming correctly.

There are five main phases of a typical peptide mapping sample treatment procedure. These include:

### 1) Denaturation

### 2) Reduction

### 3) Alkylation

4) Buffer exchange

### 5) Digestion

Typically, in both GMP and non-GMP research settings, samples are drawn by the production team and given to an analytical team for analysis. Under most circumstances, more samples are generated than can be run in a given day, due to the labor-intensive nature of the peptide mapping procedure and limited analytical resources available to process development. This forces samples through a freeze/thaw cycle, in which all samples are run at once on large robotic-arm sample handlers on a later date. Variability in biopharmaceuticals undergoing freeze-thaw cycles has been observed (K. Desai et al., Biopharm International, 2017, 30(2):30-36). This results in compromised degree of robustness that comes with large-batch sample analysis that have previously been frozen. Another complication that arises from processing samples in one batch is lacking any critical information of the biomolecule of interest in real time. In a delicate process such as biopharmaceutical drug production, knowing exactly how the drug is forming can be critical to a successful batch.

Existing sample handling devices that could perform sample pretreatment in an automated manner and keep up with the analysis demand in a production setting are deficient in holistic, hands-off approaches (Armbuster David A et al., Clinical Biochemist, 2014 35, 3: 143-53). A device that can carry out intricate sample-handling procedures, in real time, while both communicating and transporting necessary signals and samples, respectively, with auxiliary instrumentation has not existed.

Recently, a patent application (International Pat Appl WO 2019/028187 A1) described instrumentation and methods for performing these operations in an automated manner. The sample is processed by moving it in a fluidic manifold made of capillary tubing where the sample is subjected to treatment by liquid reagents, controlled temperature and solid-phase sorbents. As the liquid components are mixed inside capillary tubing, mixing is always incomplete—two adjacent liquid components form a gradient rather than a homogeneous mixture. In such a setup, full method optimization is usually not possible, as each mixing stage has to balance the degree of mixing with avoidance of excessive zone broadening. In addition, the fluidic manifold required for peptide mapping pretreatment ends up being quite complex. This is mainly due to the fact that for each step in the pretreatment process, the sample has to be moved to a new part of the manifold where that step is performed.

This application presents a system and method based on a different fluidic concept described in US Pat App 2019 16/403,390, where mixing is performed inside the barrel of a syringe pump and a barrel-shaped or tube-shaped mixing receptacle. Usage of a syringe as a mixing device keeps the sample in a confined space for each mixing operation, thus avoiding zone broadening. Furthermore, it allows formation of complete, homogeneous mixtures—thereby simplifying the method, allowing it to be fully optimized and improving its robustness. As the syringe barrel is used as a hub for fluidic handling operations, the instrument manifold is simpler, improving robustness and ease of operation even further.

### SUMMARY OF INVENTION

A recent patent application (US Pat App 2019 16/403,390) describes an instrument that mixes fluid components by moving them between a syringe pump barrel and a mixing receptacle. This application outlines specific methods and workflows on such an instrument, for the purpose of conducting sample pretreatment for peptide mapping. Thus, this application represents an extension and a new use for the apparatus in US Pat App 2019 16/403,390.

The proposed method conducts all steps of the peptide mapping pretreatment sequence and also dispenses the prepared sample to the injection loop of a High Performance Liquid Chromatograph (HPLC) for analysis.

### BRIEF DESCRIPTION OF THE DRAWINGS

FIG. 1 is a schematic representation of a setup configured to perform peptide mapping pretreatment via the steps of denaturation, reduction, alkylation, buffer exchange and digestion.

FIG. 2 is a schematic representation of a setup configured to perform peptide mapping pretreatment via the steps of denaturation, reduction, alkylation, buffer exchange and digestion. UV absorbance detection is used to check protein concentration after buffer exchange.

FIG. 3 is a schematic representation of a setup configured to perform peptide mapping pretreatment via the steps of purification, denaturation, reduction, alkylation, buffer exchange and digestion. UV absorbance detection is used to verify the purification step.

FIG. 4 is a schematic representation of a setup configured to perform peptide mapping pretreatment via the steps of purification, denaturation, reduction, alkylation, buffer exchange and digestion.

### DETAILED DESCRIPTION OF THE DISCLOSED EMBODIMENTS

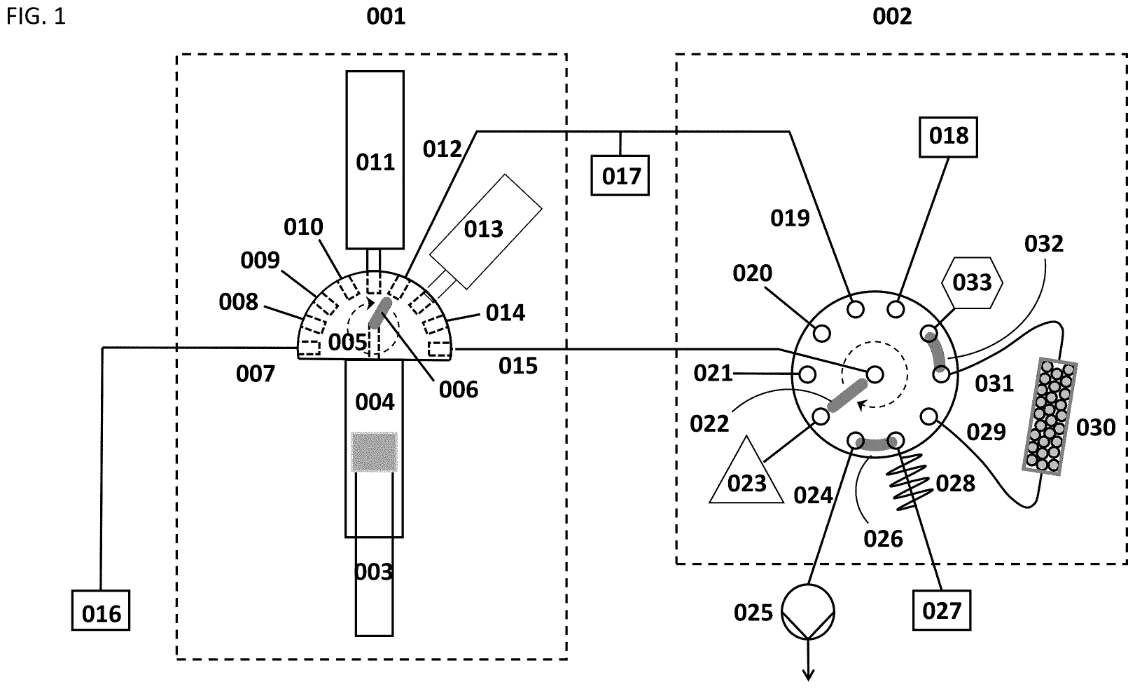

FIG. 1 lays out the plans for a basic setup that performs peptide mapping pretreatment via the steps of denaturation, reduction, alkylation, buffer exchange and digestion.
1. The sample treatment process starts by the sample being collected via the pump (025) and delivered into a coil of capillary tubing (028). Selector valve (002) turns to sampling port (028) and the piston (003) on the syringe pump module (001) aspirates to collect an aliquot of sample from the coil (028), via pump port position 015, into the syringe barrel (004).
2. Denaturation: Syringe pump module (001) changes to port position 010. Syringe pump piston (003) aspirates denature buffer into barrel (004). Syringe port position changes to 011 and the syringe pump goes through a dispense/aspirate cycle to create a homogeneous mixture and promote denaturation. After the final dispense stroke into reaction chamber (011), the sample is incubated there for a predetermined period of time so that the denaturation process can take place. In the meantime, the syringe barrel is cleaned using the desalt buffer port (014), emptying the spent cleaning solution into the waste port (012).
3. Reduction: After treatment with denature buffer, the syringe port position turns to 009 and the pump aspirates reduction agent. The syringe port then changes back to port 011 and dispenses/aspirates to promote the sample reduction. The sample then sits within the reaction chamber (011) for a predetermined period. Meanwhile, the syringe cleans the barrel with desalting buffer by aspirating the buffer from position 014 and dispensing the spent fluid into the waste port 012. The clean cycle is repeated multiple times to ensure proper cleaning.
4. Alkylation: After treatment with reduction agent, the syringe port position turns to 008 and aspirates the alkylation reagent. This mixture is alkylated by switching the syringe port back to position 011 and the syringe aspirates/dispenses to promote mixing. When the mixing phase is complete, the syringe dispenses the alkylated sample to position 011 and waits for a predetermined period of time for the reaction to take place. The syringe barrel is cleaned with the desalt buffer on syringe port 014 and emptied to waste on syringe port 012.
5. Reduction Quench: After alkylation, the sample is reduced again. To do that, the syringe port position turns to 009 and aspirates reduction agent. The syringe port then changes back to port 011 and dispenses/aspirates to promote the sample reduction.
6. Desalting: The desalting step prepares the sample for enzymatic digestion. Here, the syringe port position changes to 015 and the selector valve changes to position 029. The syringe pump dispenses all of the processed sample through the desalting column (030), via a flow-through groove (026) into a holding coil (033).
7. Enzymatic digestion: With the syringe still in position 015, the sample is aspirated from the holding coil 033 into the syringe barrel (004). The enzyme reagent is drawn from port 007 and mixed by an aspirate/dispense cycle between the syringe barrel (004) and the digestion chamber (013). The digestion chamber is held at a constant temperature while the enzyme breaks down the unfolded biomolecule. The solution is held in the reaction chamber (013) for a predetermined period while the digestion takes place. After that, the solution is acidified to below pH 4 with acid drawn from port 021.
8. Sample delivery: The syringe port position turns to 015 and the selector valve goes to 018. The pump dispenses all the fluid into the sample loop (018) on an HPLC instrument.

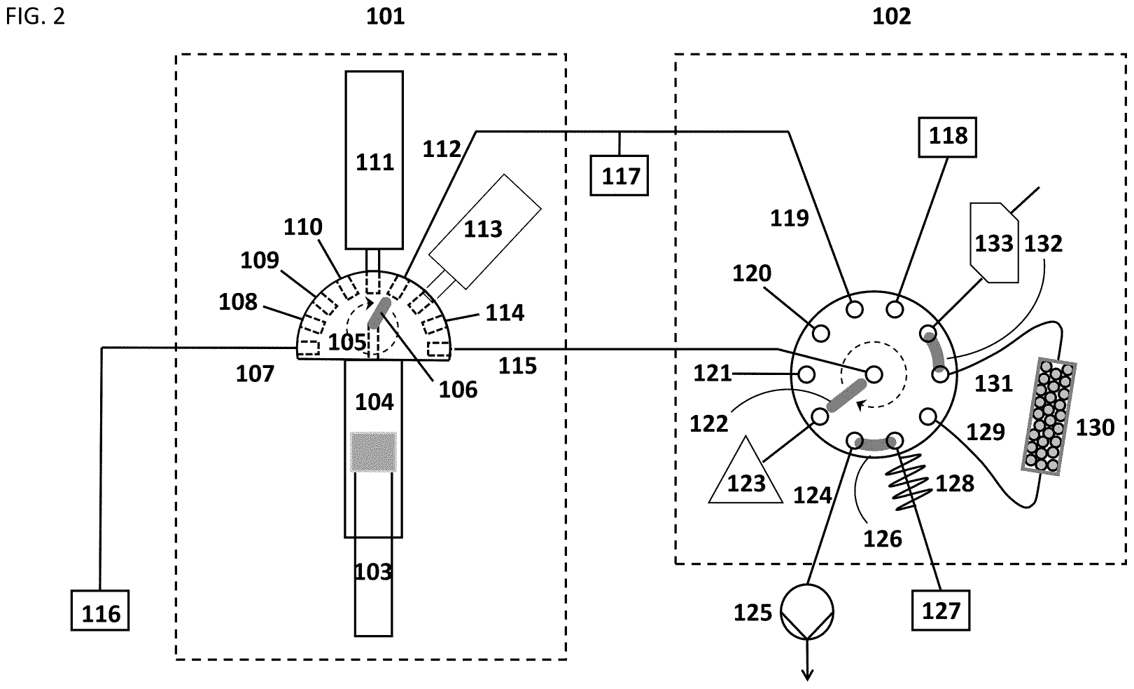

FIG. 2 lays out the plans for a basic setup that performs peptide mapping pretreatment via the steps of denaturation, reduction, alkylation, buffer exchange and digestion. Additionally, UV-VIS absorbance detection is used to monitor the effluent of the desalting column.
1. The sample treatment process starts by the sample being collected via the pump (125) and delivered into a coil of capillary tubing (128). Selector valve (102) turns to sampling port (128) and the piston (103) on the syringe pump module (101) aspirates to collect an aliquot of sample from the coil (128), via pump port position 115, into the syringe barrel (104).
2. Denaturation: Syringe pump module (101) changes to port position 110. Syringe pump piston (103) aspirates denature buffer into barrel (104). Syringe port position changes to 111 and the syringe pump goes through a dispense/aspirate cycle to create a homogeneous mixture and promote denaturation. After the final dispense stroke into reaction chamber (111), the sample is incubated there for a predetermined period of time so that the denaturation process can take place. In the meantime, the syringe barrel is cleaned using the desalt buffer port (114), emptying the spent cleaning solution into the waste port (112).
3. Reduction: After treatment with denature buffer, the syringe port position turns to 109 and the pump aspirates reduction agent. The syringe port then changes back to port 111 and dispenses/aspirates to promote the sample reduction. The sample then sits within the reaction chamber (111) for a predetermined period. Meanwhile, the syringe cleans the barrel with desalting buffer by aspirating the buffer from position 114 and dispensing the spent fluid into the waste port 112. The clean cycle is repeated multiple times to ensure proper cleaning.
4. Alkylation: After treatment with reduction agent, the syringe port position turns to 108 and aspirates the alkylation reagent. This mixture is alkylated by switching the syringe port back to position 111 and the syringe aspirates/dispenses to promote mixing. When the mixing phase is complete, the syringe dispenses the alkylated sample to position 111 and waits for a predetermined period of time for the reaction to take place. The syringe barrel is cleaned with the desalt buffer on syringe port 114 and emptied to waste on syringe port 112.
5. Reduction Quench: After alkylation, the sample is reduced again. To do that, the syringe port position turns to 109 and aspirates reduction agent. The syringe port then changes back to port 111 and dispenses/aspirates to promote the sample reduction.
6. Desalting: The desalting step prepares the sample for enzymatic digestion. Here, the syringe port position changes to 115 and the selector valve changes to position 129. The syringe pump dispenses all of the processed sample through the desalting column (130), via a flow-through groove (126) into an absorbance flow cell (133).
7. UV monitoring: The UV absorbance reading of the sample is determined by a UV detector connected to the flow cell (133).
8. Enzymatic digestion: With the syringe pump (101) still in position 115, the sample is aspirated from the absorbance flow cell (133) into the syringe barrel (104). The enzyme reagent is drawn from port 107 and mixed by an aspirate/dispense cycle between the syringe barrel (104) and the digestion chamber (113). The digestion chamber is held at a constant temperature while the enzyme breaks down the unfolded biomolecule. The solution is held in the reaction chamber (113) for a predetermined period while the digestion takes place. After that, the solution is acidified to below pH 4 with acid drawn from port 121.
9. Sample delivery: The syringe port position turns to 115 and the selector valve goes to 118. The pump dispenses all the fluid into the sample loop (118) on an HPLC instrument.

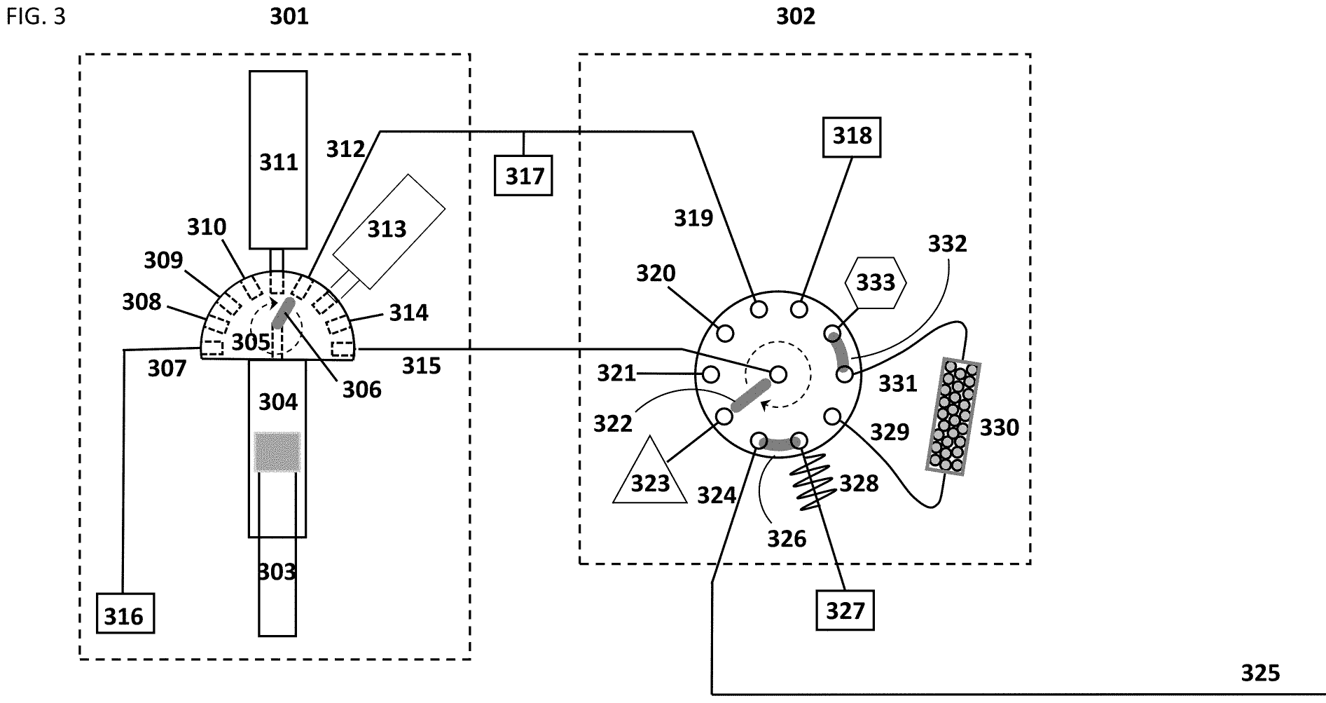

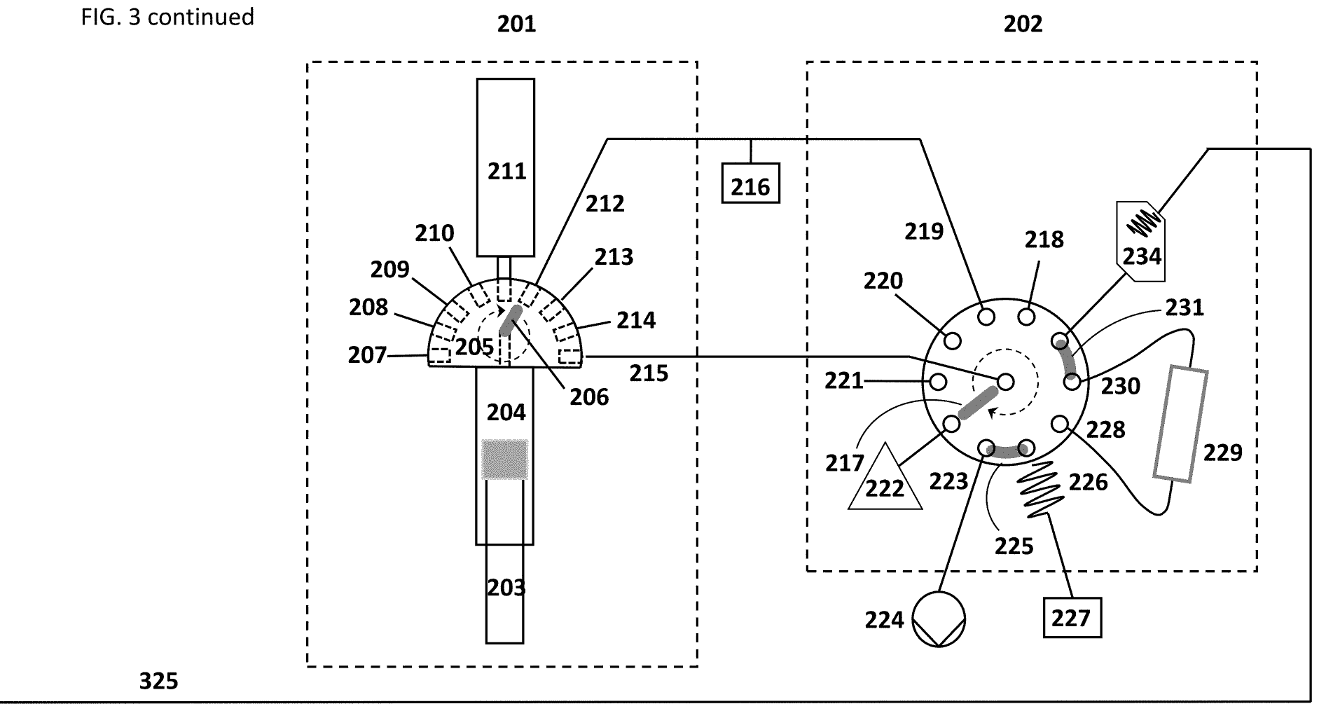

FIG. 3 lays out the plans for a setup that performs peptide mapping pretreatment via the steps of purification, denaturation, reduction, alkylation, buffer exchange and digestion. Additionally, UV-VIS absorbance detection is used to monitor the effluent of the purification column.
1. The sample treatment process starts by the sample being collected via the pump (224) and delivered into a coil of capillary tubing (227). Selector valve (202) turns to sampling port (223) and the piston (203) on the syringe pump module (201) aspirates to collect an aliquot of sample from the coil (227), via pump port position 215, into the syringe barrel (204).
2. Purification: Syringe pump (201) port position stays at 215, selector valve (202) position changes to 228 and the sample is delivered to the purification column 229. The column traps the protein of interest, along with other proteins of the same class, while other solution components flow through. Syringe pump rinses the syringe by aspirating rinse buffer from port 208 and dispensing the rinse solution to the column through port 215 on the syringe and port 228 on the selector valve. Syringe pump then repeats the rinse operation to clear unwanted solution components out of the column 229, the UV flow cell 234 and the connecting tubing 325. Syringe pump then aspirates elution buffer from port 209 and elutes the trapped protein from the purification column 229 into the UV flow cell 234. As the sample enters the UV flow cell, a UV absorbance detector is used to estimate the concentration of the purified sample. As the syringe pump (201) propels the sample further, it moves through the connecting tubing (325) into the flow-through port 326 on the selector valve 302. Finally, the sample reaches the holding coil 328 connected to the far end of the flow-through port 326.
3. Denaturation: Syringe pump module (301) changes to port position 310. Syringe pump piston (303) aspirates denature buffer into barrel (304). Syringe port position changes to 311 and the syringe pump goes through a dispense/aspirate cycle to create a homogeneous mixture and promote denaturation. After the final dispense stroke into reaction chamber (311), the sample is incubated there for a predetermined period of time so that the denaturation process can take place. In the meantime, the syringe barrel is cleaned using the desalt buffer port (314), emptying the spent cleaning solution into the waste port (312).
4. Reduction: After treatment with denature buffer, the syringe port position turns to 309 and the pump aspirates reduction agent. The syringe port then changes back to port 311 and dispenses/aspirates to promote the sample reduction. The sample then sits within the reaction chamber (311) for a predetermined period. Meanwhile, the syringe cleans the barrel with desalting buffer by aspirating the buffer from position 314 and dispensing the spent fluid into the waste port 312. The clean cycle is repeated multiple times to ensure proper cleaning.
5. Alkylation: After treatment with reduction agent, the syringe port position turns to 308 and aspirates the alkylation reagent. This mixture is alkylated by switching the syringe port back to position 311 and the syringe aspirates/dispenses to promote mixing. When the mixing phase is complete, the syringe dispenses the alkylated sample to position 311 and waits for a predetermined period of time for the reaction to take place. The syringe barrel is cleaned with the desalt buffer on syringe port 314 and emptied to waste (318) on syringe port 312.
6. Reduction Quench: After alkylation, the sample is reduced again. To do that, the syringe port position turns to 309 and aspirates reduction agent. The syringe port then changes back to port 311 and dispenses/aspirates to promote the sample reduction.
7. Desalting: The desalting step prepares the sample for enzymatic digestion. Here, the syringe port position changes to 315 and the selector valve changes to position 329. The syringe pump dispenses all of the processed sample through the desalting column (330), via a flow-through groove (332) into a holding coil (333).
8. Enzymatic digestion: With the syringe still in position 315, the sample is aspirated from the holding coil 333 into the syringe barrel (304). The enzyme reagent is drawn from port 307 and mixed by an aspirate/dispense cycle between the syringe barrel (304) and the digestion chamber (313). The digestion chamber is held at a constant temperature while the enzyme breaks down the unfolded biomolecule. The solution is held in the reaction chamber (313) for a predetermined period while the digestion takes place. After that, the solution is acidified to below pH 4 with acid drawn from port 321.
9. Sample delivery: The syringe port position turns to 315 and the selector valve goes to 318. The pump dispenses all the fluid into the sample loop (318) on an HPLC instrument.

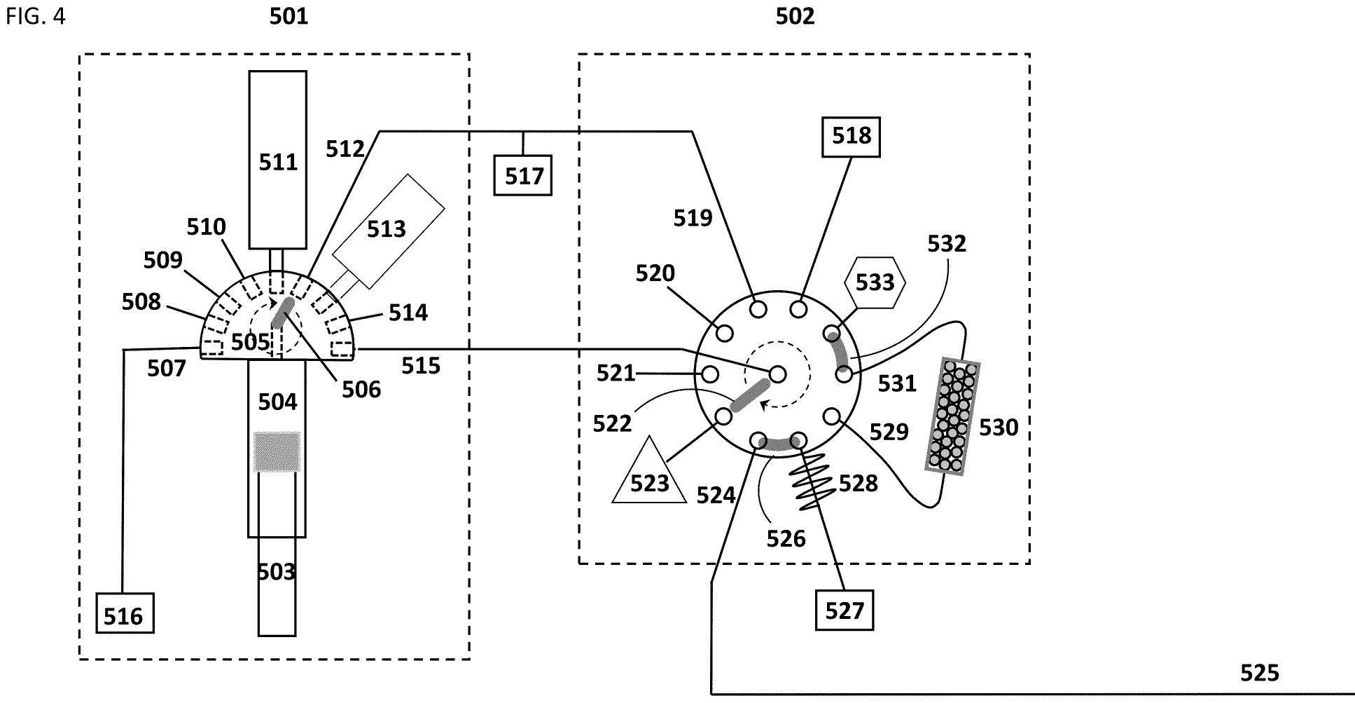

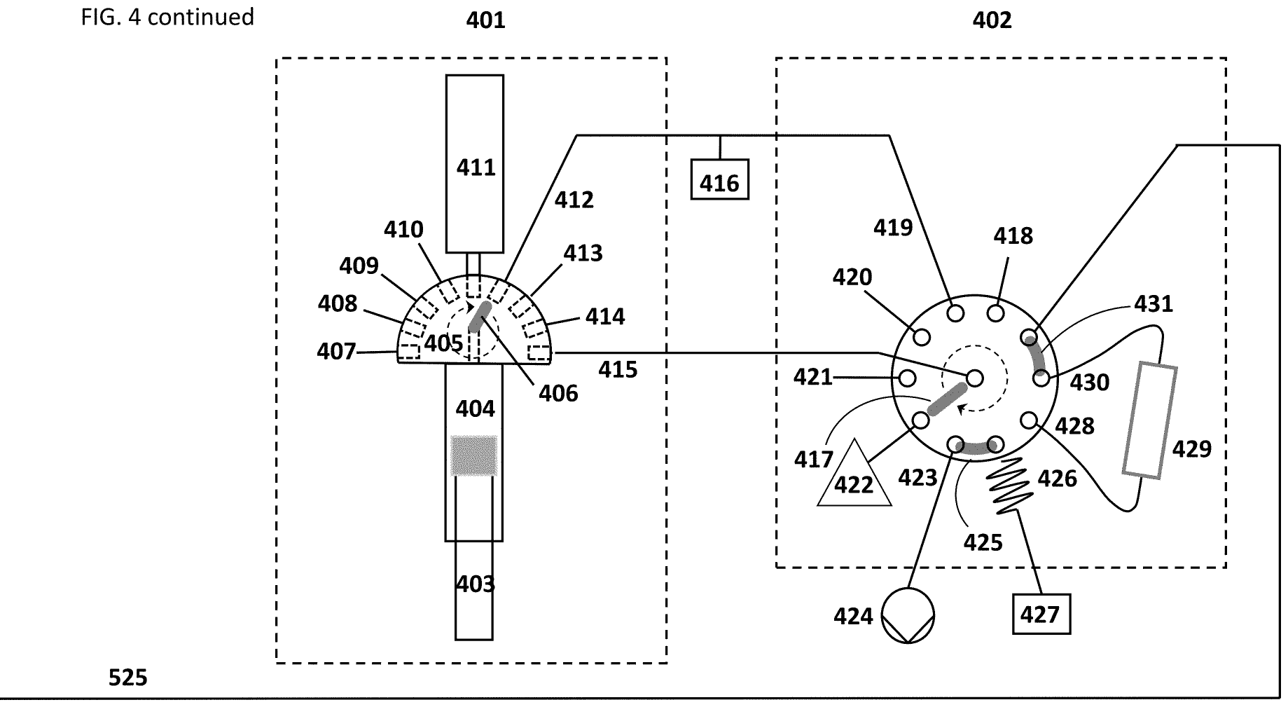

FIG. 4 lays out the plans for a setup that performs peptide mapping pretreatment via the steps of purification, denaturation, reduction, alkylation, buffer exchange and digestion.
1. The sample treatment process starts by the sample being collected via the pump (424) and delivered into a coil of capillary tubing (427). Selector valve (402) turns to sampling port (423) and the piston (403) on the syringe pump module (401) aspirates to collect an aliquot of sample from the coil (427), via pump port position 415, into the syringe barrel (404).
2. Purification: Syringe pump (401) port position stays at 415, selector valve (402) position changes to 428 and the sample is delivered to the purification column 429. The column traps the protein of interest, along with other proteins of the same class, while other solution components flow through. Syringe pump rinses the syringe by aspirating rinse buffer from port 408 and dispensing the rinse solution to the column through port 415 on the syringe and port 428 on the selector valve. Syringe pump then repeats the rinse operation to clear unwanted solution components out of the column 429 and the connecting tubing 525. Syringe pump then aspirates elution buffer from port 209 and elutes the trapped protein from the purification column 229. As the syringe pump (201) propels the sample out of the column, it moves through the connecting tubing (525) into the flow-through port 526 on the selector valve 502. Finally, the sample reaches the holding coil 528 connected to the far end of the flow-through port 526.
3. Denaturation: Syringe pump module (501) changes to port position 510. Syringe pump piston (503) aspirates denature buffer into barrel (504). Syringe port position changes to 511 and the syringe pump goes through a dispense/aspirate cycle to create a homogeneous mixture and promote denaturation. After the final dispense stroke into reaction chamber (511), the sample is incubated there for a predetermined period of time so that the denaturation process can take place. In the meantime, the syringe barrel is cleaned using the desalt buffer port (514), emptying the spent cleaning solution into the waste port (512).
4. Reduction: After treatment with denature buffer, the syringe port position turns to 509 and the pump aspirates reduction agent. The syringe port then changes back to port 511 and dispenses/aspirates to promote the sample reduction. The sample then sits within the reaction chamber (511) for a predetermined period. Meanwhile, the syringe cleans the barrel with desalting buffer by aspirating the buffer from position 514 and dispensing the spent fluid into the waste port 512. The clean cycle is repeated multiple times to ensure proper cleaning.
5. Alkylation: After treatment with reduction agent, the syringe port position turns to 308 and aspirates the alkylation reagent. This mixture is alkylated by switching the syringe port back to position 511 and the syringe aspirates/dispenses to promote mixing. When the mixing phase is complete, the syringe dispenses the alkylated sample to position 511 and waits for a predetermined period of time for the reaction to take place. The syringe barrel is cleaned with the desalt buffer on syringe port 514 and emptied to waste (518) on syringe port 512.
6. Reduction Quench: After alkylation, the sample is reduced again. To do that, the syringe port position turns to 509 and aspirates reduction agent. The syringe port then changes back to port 511 and dispenses/aspirates to promote the sample reduction.
7. Desalting: The desalting step prepares the sample for enzymatic digestion. Here, the syringe port position changes to 515 and the selector valve changes to position 529. The syringe pump dispenses all of the processed sample through the desalting column (530), via a flow-through groove (532) into a holding coil (533).
8. Enzymatic digestion: With the syringe still in position 515, the sample is aspirated from the holding coil 533 into the syringe barrel (504). The enzyme reagent is drawn from port 507 and mixed by an aspirate/dispense cycle between the syringe barrel (304) and the digestion chamber (513). The digestion chamber is held at a constant temperature while the enzyme breaks down the unfolded biomolecule. The solution is held in the reaction chamber (513) for a predetermined period while the digestion takes place. After that, the solution is acidified to below pH 4 with acid drawn from port 521.
9. Sample delivery: The syringe port position turns to 515 and the selector valve goes to 518. The pump dispenses all the fluid into the sample loop (518) on an HPLC instrument.

The previously unknown feature of the present invention is automating the peptide mapping pretreatment operations with a fluidic device that combines the sample with reagents in such a manner that the resulting solution is a homogeneous mixture. Another previously unknown feature is that an automated enzymatic digestion step is carried out with a liquid enzyme reagent, as opposed to a solid-phase immobilized column. Another previously unknown feature is that in-line UV-VIS measurements can be used to monitor the efficiency of either the desalting or the purification step.

While certain specific details and embodiments have been described to illustrate the principles of the present invention, it will be apparent to those skilled in the art that many modifications are possible within the scope of the disclosed invention.

### PATENT CITATIONS

International Patent Application WO 2019/028187 A1, Amgen Inc, Systems and methods for real time preparation of a polypeptide sample for analysis with mass spectrometry
U.S. patent application Ser. No. 16/403,390, Ilkka Landesmaki, Fluidic sample pretreatment device

### JOURNAL CITATIONS

Armbruster, David A et al. “Clinical Chemistry Laboratory Automation in the 21st Century—Amat Victoria curam (Victory loves careful preparation).” The Clinical biochemist. Reviews vol. 35, 3 (2014): 143-53.
K. Desai et al., “Impact of Manufacturing-Scale Freeze-Thaw Conditions on a mAb Solution,” BioPharm International February 2017. Vol. 30 (2):30-36
Trina Mouchahoir and John E. Schiel. Analytical and Bioanalytical Chemistry 2018. 410:2111-2126

What is claimed is:

1. A method for automated sample pretreatment for peptide mapping where
a. The sample is mixed with denaturation buffer by pumping aliquots of the two solutions back and forth between a syringe and a reaction chamber.
b. The resulting mixture is mixed with a reducing agent by pumping aliquots of the solutions back and forth between a syringe and a reaction chamber.
c. The resulting mixture is mixed with an alkylating agent by pumping aliquots of the two solutions back and forth between a syringe and a reaction chamber.
d. The alkylation reaction is quenched with a reduction agent by pumping an aliquot of the mixture from step c. with an aliquot of a reducing agent and pumping the two solutions back and forth between a syringe and a reaction chamber.
e. The resulting mixture is desalted by pushing it through a desalting column into a holding coil.
f. The desalted solution is drawn from the holding coil into a syringe barrel, followed by an enzyme reagent. The two solutions are mixed by pumping them back and forth between the syringe and a reaction chamber.
g. The sample is left in the reaction chamber to be digested.
h. The digestion is stopped by drawing the mixture into the syringe, followed by an aliquot of acid. The two solutions are mixed by pumping them back and forth between the syringe and a reaction chamber.
i. The sample is pushed into the injection loop of an HPLC instrument.

2. A method for automated sample pretreatment for peptide mapping where
a. The sample is mixed with denaturation buffer by pumping aliquots of the two solutions back and forth between a syringe and a reaction chamber.
b. The resulting mixture is mixed with a reducing agent by pumping aliquots of the solutions back and forth between a syringe and a reaction chamber.
c. The resulting mixture is mixed with an alkylating agent by pumping aliquots of the two solutions back and forth between a syringe and a reaction chamber.
d. The alkylation reaction is quenched with a reduction agent by pumping an aliquot of the mixture from step c. with an aliquot of a reducing agent and pumping the two solutions back and forth between a syringe and a reaction chamber.
e. The resulting mixture is desalted by pushing it through a desalting column into a holding coil.
f. The desalted solution is drawn from the holding coil into a syringe barrel, followed by an enzyme reagent. The two solutions are mixed by pumping them back and forth between the syringe and a reaction chamber.
g. The sample is left in the reaction chamber to be digested.
h. The digestion is stopped by drawing the mixture into the syringe, followed by an aliquot of acid. The two solutions are mixed by pumping them back and forth between the syringe and a reaction chamber.
i. The sample is pushed into the injection loop of an HPLC instrument.
